(19) United States
(12) Patent Application Publication
(10) Pub. No.: US 2024/0281214 A1
(43) Pub. Date: Aug. 22, 2024

(54) METHOD FOR SELECTING A VALUE AMONGST TWO VALUES RECORDED IN TWO DIFFERENT REGISTERS

(71) Applicant: STMicroelectronics International N.V., Geneva (CH)

(72) Inventor: Thierry SIMON, Wezembeek-Oppem (BE)

(73) Assignee: STMicroelectronics International N.V., Geneva (CH)

(21) Appl. No.: 18/439,297

(22) Filed: Feb. 12, 2024

(30) Foreign Application Priority Data
Feb. 22, 2023 (FR) 2301610

(51) Int. Cl. G06F 7/76; H04L 9/30

(52) U.S. Cl. CPC G06F 7/764; H04L 9/3066; H04L 2209/046

(57) ABSTRACT

A method includes performing a cryptographic operation using a processing device. The performing the cryptographic operation includes protecting the performing of the cryptographic operation against side channel attacks by selecting a value amongst two values based on a selection bit. Selecting the value includes concatenating the two values in a register, generating a concatenated word including the two values in two distinct portions of the concatenated word in the register. The concatenated word is rotated according to the value of the selection bit to position the selected value in a determined portion of the concatenated word in the register amongst said two portions. The unselected value in the concatenated word is suppressed. One or more processing operations is performed based on a result of the cryptographic operation.

### BACKGROUND

### Technical Field

Embodiments and implementations relate to computer systems, in particular a method for selecting a value amongst two values recorded in two different registers of the computer system from a selection bit.

### Description of the Related Art

Some applications of a computer system require selecting a value amongst two values recorded in two different registers of this computer system. This value selection may be carried out from a selection bit that the user wishes to keep secret.

In particular, the selection of a value amongst two values stored in two different registers may be carried out in the context of cryptographic processes. For example, algorithms calculating a modular exponentiation in a finite body or a scalar multiplication on an elliptic curve could implement such a selection. These algorithms are used in “RSA” and “ElGamal” cryptosystems, the “DSA” (acronym for “Digital Signature Algorithm”) and “ECDSA” (acronym for “Elliptic curve digital signature algorithm”) algorithms and the “ECDH” (acronym for “Elliptic-curve Diffie-Hellman”) protocol. For example, the selection bit is a bit of a cryptographic key that the user wishes to keep secret.

Moreover, handling data in a computer system may cause a change in the energy consumption of the processing unit carrying out this data handling.

Handling the data may also result in a change in the execution time depending on the handled data. In particular, a computer system may use a cache memory. This cache memory may temporarily store data. Access to the data stored in cache is carried out more rapidly than access to the data stored in a memory for which the cache memory serves as an intermediary.

Handling the data may also cause a change of the electromagnetic field of the processing unit handling the data.

These changes are physical observations that could be used by an attacker wishing to recover information from the computer system. These observations are referred to by the expression “side-channel attack” (“Side-channel attack”)

In particular, an attacker might look to know the value of the selection bit used to select a value amongst two values recorded in different registers. Yet, the selection of a value amongst two values recorded in two different registers is carried out by executing computer instructions that could for example cause changes in energy consumption and/or in execution time or in electromagnetic fields. These changes could be observed by an attacker. The observation of these changes could enable the attacker to determine the value of the selection bit.

Thus, for example, in the context of the aforementioned cryptographic methods, the attacker could observe the changes to determine each bit of the cryptographic key. This enables the attacker to recover the cryptographic key which he could maliciously use afterwards.

Several solutions allowing carrying out a selection amongst two values recorded in different registers are known.

A first known solution consists in implementing an if-then-else function (“if-then-else”) in which the assessed condition is the value of the selection bit.

The implementation of the if-then-else function uses sequences of instructions which are different depending on the value of the selection bit. These sequences of instructions may result in a different execution time, in a different energy consumption or in a different magnetic field. Therefore, an attacker could determine the value of the selection bit according to his observations.

A second solution consists in setting said two values in a table, then in accessing in the table to the value selected from the value of the selection bit. This solution may involve the use of a cache memory during the memory accesses carried out according to the value of the selection bit. The use of the cache memory could modify the access times of the memory accesses according to the value of the selection bit. On an architecture supporting a cache, it is then possible for an attacker to find the value of the selection bit according to the observed times of access to the memory.

A third solution consists in using a mask on the values to be selected, the used mask depending on the selection bit. For example, on a 32-bit architecture, the mask may have as a value 0xFFFFFFFF or 0x00000000 depending on the value of the selection bit. Nevertheless, these masks have very different Hamming weights (number of bits at 1). Thus, the energy consumption for the use of these masks could considerably vary depending on the used mask. If the difference in energy consumption due to the use of the masks is enough to be observed, an attacker could find the value of the selection bit.

A fourth solution is described in U.S. Patent Publication No. 2021/0306134 by Bocchi. This solution uses masks having the same Hamming weight on a 32-bit architecture. In particular, the masks correspond to an alternation of 1 bits and 0 bits. In particular, the masks have as a value 0xAAAAAAAA or 0x55555555 depending on the value of the selection bit. The value of the mask is obtained by performing or by not performing a shift of the value 0xAAAAAAAA to the right by one bit depending on the value of the selection bit. If the shift takes place, the 32 bits of the register simultaneously change value. Otherwise, no bit changes value. Such a difference may also generate a considerable variation in energy consumption depending on the considered hardware (“hardware”). If the difference in energy consumption due to the use of the masks is enough to be observed, an attacker could find the value of the selection bit.

### BRIEF SUMMARY

According to one aspect, a method implemented by a computer—in particular by a computer system as described hereafter, for example a system-on-chip—is provided for selecting a value amongst two values recorded in two different registers from a selection bit, the method comprising:
concatenating the two values recorded in the two registers so as to obtain a concatenated word including said two values in two distinct portions of the concatenated word, then
rotating said concatenated word according to the value of the selection bit so as to position the selected value in a given portion of the concatenated word amongst said two portions, then
suppressing the unselected value in the concatenated word so as to keep only the selected value in the concatenated word by eliminating the unselected value of the concatenated word.

Such a selection method has the advantage of being implemented by a sequence of instructions independent of the value of the selection bit and does not contain memory accesses dependent on the selection bit.

In particular, such a selection method has the advantage of being robust against side-channel attacks.

In an embodiment, said deletion of the unselected value in the concatenated word comprises shifting the concatenated word so as to keep only the selected value in the concatenated word by eliminating the unselected value of the concatenated word.

Advantageously, the concatenation allows concatenating two values over 16 bits so as to obtain a 32-bit concatenated word in which the two values are comprised within two 16-bit portions of the concatenated word.

In an advantageous implementation, said rotation of said concatenated word comprises:
a first rotation of the concatenated word according to a determined number M of bits, M being different from 0 and from a multiple of 16, then
a second rotation of the concatenated word according to a number of bits dependent on the selection bit so as to obtain the selected value over said given portion. The determined number M may be a predetermined value or a default value.

Carrying out a rotation in two steps facilitates avoiding performing a 0-bit rotation when the selection bit is 0. Indeed, such a rotation, which does not modify the value contained in the register, could be observed by an attacker.

Advantageously, the number of shift bits for the second rotation may be determined by carrying out:
an OR logic function between the value of the selection bit and a value equal to 0xN0000000 where N is comprised between 1 and F in the hexadecimal system and is defined with respect to the determined number M of bits for the first rotation, then
a rotation by 28 bits on the value obtained by the OR logic function so as to obtain a value of the number of shift bits for the second rotation.

According to another aspect, a computer program product is provided comprising instructions which, when the program is executed by a computer, cause the latter to implement a selection method as described herein.

According to another aspect, a computer system is provided comprising:
a memory in which a computer program product as described herein is stored, and
a processing unit configured to execute said computer program product.

In particular, the processing unit has an architecture supporting a rotation of the register content.

In an embodiment, a method includes performing a cryptographic operation using a processing device. The performing the cryptographic operation includes protecting the performing of the cryptographic operation against side channel attacks by selecting a value amongst two values based on a selection bit. Selecting the value includes concatenating the two values in a register, generating a concatenated word including the two values in two distinct portions of the concatenated word in the register. The concatenated word is rotated according to the value of the selection bit to position the selected value in a determined portion of the concatenated word in the register amongst said two portions. The unselected value in the concatenated word is suppressed. One or more processing operations is performed based on a result of the cryptographic operation.

In an embodiment, a non-transitory computer-readable medium's contents cause a processing device to perform a method. The method includes performing a cryptographic operation using a processing device. The performing the cryptographic operation includes protecting the performing of the cryptographic operation against side channel attacks by selecting a value amongst two values based on a selection bit. Selecting the value includes concatenating the two values in a register, generating a concatenated word including the two values in two distinct portions of the concatenated word in the register. The concatenated word is rotated according to the value of the selection bit to position the selected value in a determined portion of the concatenated word in the register amongst said two portions. The unselected value in the concatenated word is suppressed. One or more processing operations is performed based on a result of the cryptographic operation.

In an embodiment, a system comprises a plurality of registers, and processing circuitry coupled to the plurality of registers. The processing circuitry, in operation, performs a cryptographic operation. The performing the cryptographic operation includes protecting the performing of the cryptographic operation against side channel attacks by selecting a value amongst two values based on a selection bit. Selecting the value includes concatenating the two values in a register of the plurality of registers, generating a concatenated word including the two values in two distinct portions of the concatenated word in the register. The concatenated word is rotated according to the value of the selection bit to position the selected value in a determined portion of the concatenated word in the register amongst said two portions. The unselected value in the concatenated word is suppressed. One or more processing operations is performed based on a result of the cryptographic operation.

In an embodiment, a device comprises a plurality of registers, and cryptographic circuitry coupled to the plurality of registers. The cryptographic circuitry, in operation performs a cryptographic operation, the performing the cryptographic operation including protecting the performing of the cryptographic operation against side channel attacks by selecting a value amongst two values based on a selection bit. The selecting the value includes: concatenating the two values in a register of the plurality of registers, generating a concatenated word including the two values in two distinct portions of the concatenated word in the register; rotating the concatenated word according to the value of the selection bit to position the selected value in a determined portion of the concatenated word in the register amongst said two portions; and suppressing the unselected value in the concatenated word.

### BRIEF DESCRIPTION OF THE SEVERAL VIEWS OF THE DRAWINGS

Other advantages and features of the disclosure will appear upon examining the detailed description of non-limiting embodiments, and the appended drawings wherein:

FIG. 1 illustrates an embodiment of a method of selecting a value from two values stored in two different registers.

FIG. 2 illustrates an embodiment of a computing system in which embodiments of the method of FIG. 1 may be employed.

FIG. 3 illustrates an embodiment of a method of performing a cryptographic operation and protecting the performing of the cryptographic operation against side channel attacks.

### DETAILED DESCRIPTION

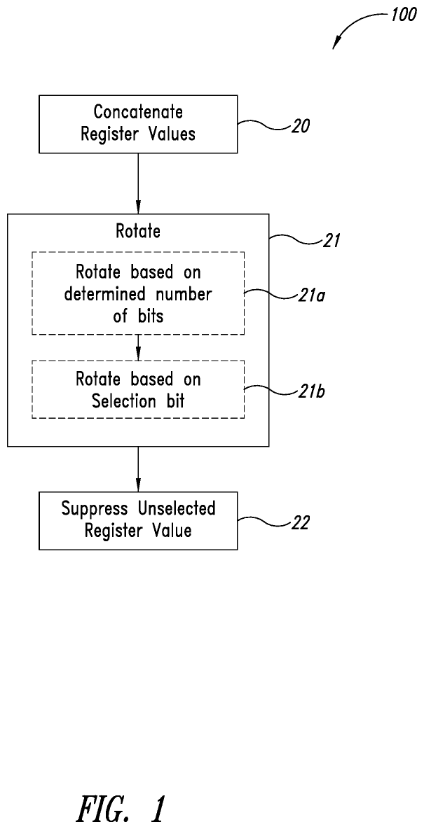

FIG. 1 illustrates an implementation of a method 100 that may be implemented by a computer (in particular by a computer system as described hereafter), for selecting a value amongst two values recorded in two different registers of the computer from a selection bit.

The selection bit is stored in a register of the computer. This selection bit is a secret selection bit.

Each of these values may be represented over 16 bits. Alternatively, each of these values may be represented over 32 bits.

When each value is represented over 32 bits, the steps of the selection method described hereinbelow are carried out a first time on the 16 high-weight bits of each value then a second time on the 16 low-weight bits of each value, or vice versa.

In other words, the steps of the method are carried out a first time to select the 16 high-weight bits of a value amongst the two values depending on the selection bit, then a second time to select the 16 low-weight bits of this same value, or vice versa. Afterwards, the selected high-weight bits and low-weight bits are concatenated to obtain the selected value.

The method comprises a concatenation step 20 in which the two values recorded in the two different registers are concatenated. The concatenation of the two values allows obtaining concatenated word. This concatenated word then has a first portion including a first value and a second portion including the second value. The two portions comprise the same number of bits. For example, each portion comprises 16 bits so that the concatenated word includes 32 bits.

Afterwards, the method comprises a rotation step 21 in which a rotation operation is carried out on the bits of the concatenated word. The rotation operation is carried out according to the value of the selection bit. For example, the rotation of the concatenated word is carried out so as to place the bits of the value selected by the selection bit over the high-weight bits of the concatenated word. In particular, when the concatenated word comprises two 16-bit portions, the performed rotation is a 16-bit or 32-bit rotation depending on the value of the selection bit.

The operation 21 of rotation of the concatenated word may be carried out in two steps. In particular, the method may comprise a first rotation 21a of the concatenated word according to a determined number M of bits. The number M may be comprised between 1 and 15 for example.

Afterwards, the method may comprise a second rotation 21b of the concatenated word according to a number of bits dependent on the selection bit so as to obtain the selected value over the portion with high-weight bits of the concatenated word.

For example, the number of shift bits for the second rotation is determined by firstly performing an OR logic function between the value of the selection bit and a value equal to 0xN0000000 where N is comprised between 1 and F in the hexadecimal system and is defined with respect to the number M of bits determined for the first rotation. The OR logic function then allows obtaining a value equal to 0xN0000000 when the selection bit is equal to 0, and 0xN0000001 when the selection bit is equal to 1. Afterwards, a rotation by 28 bits to the right is carried out so as to obtain a value equal to 0x0000000N when the selection bit is equal to 0 and to 0x0000001N.

This calculated value defines the number of shift bits for the second rotation.

The first rotation and the second rotation allow carrying out a rotation of the concatenated word by a number of bits equal to M+N₁₆ if the selection bit is equal to 0 or to M+(IN)₁₆. The values of M and N are selected so that the sum M+N₁₆ is equal to 16 (in the decimal system) and so that the sum M+(IN)₁₆ is equal to 32 (in the decimal system).

Carrying out a rotation 21 in two steps (a first rotation 21a then a second rotation 21b) facilitates avoiding the rotation being directly over 0 bit (when the rotation is over 32 bits) or over 16 bits. Hence, the first rotation allows having a modification of the concatenated word regardless of the value of the selection bit. In this manner, the determination of the selection bit from an observation of the rotation is made more complex.

Once the rotation operation 21 is performed on the concatenated word, the value selected by the selection bit is over a given portion of the concatenated word, for example the 16 high-weight bits of the concatenated word, over the first portion of the concatenated word. The value that is not selected by the selection bit is then over the 16 low-weight bits of the concatenated word, over the second portion of the concatenated word.

The method then comprises a suppression step 22 in which the unselected value is deleted from the concatenated word. In particular, the suppression step 22 may, for example, comprise a shift operation on the concatenated word so as to keep only the value selected by the selection bit. For example, a shift by 16 bits to the right is carried out so as to place the selected value over the 16 low-weight bits of the concatenated word, over the second portion of the concatenated word. Thus, the unselected value is eliminated from the concatenated word to keep only the selected value in the concatenated word.

Alternatively, a mask may be applied on the concatenated word to suppress the unselected value and keeps only the selected value.

Such a selection method has the advantage, at least for some architectures, of being able to be executed during an execution time that is the same regardless of the value of the selection bit. Indeed, the selection method comprises the same sequence of instructions to be executed regardless of the value of the selection bit.

Such a selection method has the advantage of being robust against side-channel attacks.

The tables [Table 1] to [Table 4] illustrate different examples of implementation of the previously-described method. These tables show the instructions executed by the computer. The instructions are herein represented in assembled language for an ARM Cortex®-M3 processor. The tables [Table 1] and [Table 2] illustrate examples of implementation of the same method when the selection is carried out amongst-two 16-bit values according to the value of the selection bit. The tables [Table 3] and [Table 4] illustrate examples of implementation of another method in which the selection is carried out amongst two 32-bit values according to the value of the selection bit.

The table [Table 1] illustrates an example of implementation of the method when the two values v0 and v1 initially stored in the registers r0 and r1 are over 16 bits, and when the value of the selection bit Sel_bit initially stored in the register r2 is equal to 0 so as to select the value v0 stored in the register r0.

TABLE 1
Sel_bit = 0

| No | | | Registre | |
|---|---|---|---|---|
| Instruction | Instruction | Registre r0 | r1 | Registre r2 |
| #0 | État initial | v0 | v1 | Sel_bit = 0 |
| #1 | EOR r0, r0, r1, LSL | v1 ∥ v0 | | |
| | #16 | | | |
| #2 | ROR r0, r0, #1 | (v1 ∥ v0) >>> | | |
| | | 1 | | |
| #3 | ORR | | | 0xF0000000 |
| | r2, r2, =0xF0000000 | | | |
| #4 | ROR r2, r2, #28 | | | 0x0000000F = |
| | | | | 15 |
| #5 | ROR r0, r0, r2 | v0 ∥ v1 | | |
| #6 | LSR r0, r0, #16 | v0 | | |

The instruction #1 is an instruction “EOR r0, r0, r1, LSL #16.” This instruction allows concatenating the values v0 and v1 stored in the registers r0 and r1 so as to obtain a concatenated word v1∥v0 and allows recording this concatenated word v1∥v0 in the register r0. In particular, this instruction allows shifting by 16 bits to the left, the value v1 represented over 16 bits before performing a XOR logic operation between this shifted value v1 with the value v0 to obtain the concatenated word v1∥v0. The concatenated word then has a first portion with 16 high-weight bits including the value v1 and a second portion of 16 low-weight bits including the value v0.

The instruction #2 is an instruction “ROR r0, r0, #1.” This instruction allows carrying out an operation of rotation by 1 bit to the right on the concatenated word v1∥v0 so as to obtain a concatenated word shifted by 1 bit by rotation to the right (v1∥v0)>>>1. This shifted concatenated word is recorded in the register r0.

The instruction #3 is an instruction “ORR r2, r2, =0xF0000000.” This instruction allows performing an OR logic operation between the value of the selection bit Sel_bit stored in the register r2 and the value 0xF0000000 (herein represented according to the hexadecimal system), and allows recording the result of this operation in the register r2. The value of the selection bit being herein equal to 0, the result of the OR logic operation is equal to 0xF0000000.

The instruction #4 is an instruction “ROR r2, r2, #28.” This instruction allows carrying out an operation of rotation by 28 bits to the right on the result of the OR logic operation stored in the register r2, and allows recording the result of this rotation operation in the register r2. In this case, the result of the rotation operation is equal to 0x0000000F in the hexadecimal system, 15 in the decimal system.

The instruction #5 is an instruction “ROR r0, r0, r2.” This instruction allows carrying an operation of rotation to the right by a number of bits corresponding to the value recorded in the register r2 (herein 0x0000000F, a rotation by 15 bits to the right) on the shifted concatenated word (v1∥v0)>>>1 stored in the register r0, and allows recording the result of this rotation operation in the register r0. In this case, the result of this 15-bit rotation operation corresponds to the concatenated word v0∥v1 which has a first portion of 16 high-weight bits including the value v0 and a second portion of 16 low-weight bits including the value v1. Thus, this result corresponds to a 16-bit rotation of the concatenated word v1∥v0.

The instruction #6 corresponds to an instruction “LSR r0, 10, #16.” This instruction allows carrying out an operation of shifting to the right by 16 bits on the concatenated word v0∥v1 resulting from the rotation operation, and allows recording the result of this shift operation in the register r0. This shift operation allows eliminating the unselected value v1 and keeping only the selected value v0.

The table [Table 2] illustrates an example of implementation of the method when the two value v0 and v1 initially stored in the register r0 and r1 are over 16 bits, and when the value of the selection bit Sel_bit initially stored in the register r2 is equal to 1 so as to select the value v1.

TABLE 2
Sel_bit = 1

| No | | | Registre | Registre |
|---|---|---|---|---|
| Instruction | Instruction | Registre r0 | r1 | r2 |
| #0 | État initial | v0 | v1 | Sel_bit = 1 |
| #1 | EOR r0, r0, r1, LSL | v1 ∥ v0 | | |
| | #16 | | | |
| #2 | ROR r0, r0, #1 | (v1 ∥ v0) >>> | | |
| | | 1 | | |
| #3 | ORR | | | 0xF0000001 |
| | r2, r2, =0xF0000000 | | | |
| #4 | ROR r2, r2, #28 | | | 0x0000001F = |
| | | | | 31 |
| #5 | ROR r0, r0, r2 | v1 ∥ v0 | | |
| #6 | LSR r0, r0, #16 | v1 | | |

The instructions are identical to those described with reference to the table [Table 1]. Nevertheless, the results of the operations carried out by the execution of these instructions differ from those of the table [Table 1] because the value of the selection bit is equal to 1 and no longer 0.

In particular, the result of the OR logic operation of the instruction #3 is equal to 0xF0000001, and no longer 0xF0000000. Thus, the result of the rotation operation of the instruction #4 is equal to 0x0000001F, 31 in the decimal system.

Hence, the rotation operation carried out by the instruction #5 is a rotation over 31 bits, and no longer over 15 bits. Thus, the result of this rotation operation corresponds to the concatenated word v1∥v0. This concatenated word v1∥v0 has a first portion of 16 high-weight bits including the value v1 and a second portion of 16 low-weight bits including the value v0. This result corresponds to a 32-bit rotation of the concatenated word v1∥v0 obtained after the execution of the instruction #2.

Consequently, the result of the shift operation of the instruction #6 is equal to the selected value v1.

The executed instructions are the same regardless of the value of the selection bit. Thus, the execution time of the method is the same regardless of the value of the selection bit on an architecture where the execution time of the used instructions is constant. This allows making the identification of the value of the selection bit complex for an attacker.

Furthermore, the value of the register r2 differs only by one bit depending on the values of the selection bit. Thus, it is complex for an attacker to identify a change in the register r2 according to the selection bit. Hence, it is complex to identify the value of the selection bit by observing the register r2.

In addition, as indicated before, carrying out a rotation of the concatenated word in two steps (a first 1-bit rotation then a second 15- or 31-bit rotation) allows avoiding the rotation being directly done by 0 or 16 bits. In particular, a 0-bit rotation could be detected by an attacker. The rotation of the concatenated word in two steps allows making the identification of the value of the selection bit complex.

Moreover, the method allows keeping a constant Hamming weight in the register r0 until the instruction #6. In other words, the method allows keeping the same number of bits at 1 in the values of the register. Therefore, the identification of the value of the selection bit is made complex for an attacker.

The tables [Table 3] and [Table 4] illustrate examples of implementation of a method for selecting amongst two 32-bit values according to the value of the selection bit.

The table [Table 3] illustrates an example of implementation of the method when the two values v0 and v1 initially stored in the registers r0 and r1 are represented over 32 bits, and when the value of the selection bit Sel_bit initially stored in the register r2 is equal to 0 so as to select the values v0 stored in the register r0. The value v0 comprises 16 high-weight bits v0^{H} and 16 low-weight bits v0^{L}. The value v1 comprises 16 high-weight bits v1H and 16 low-weight bits v1^{L}.

TABLE 3
Sel_bit = 0

| No Instruction | Instruction | Registre r0 | Registre r1 | Registre r2 | Registre r3 |
|---|---|---|---|---|---|
| #0 | État initial | v0 = v0^{H} ∥ v0^{L} | v1 = v1^{H} ∥ v1^{L} | Sel_bit = 1 | |
| #1 | UXTH r3, r0 | | | | v0^{L} |
| #2 | EOR r3, r3, r1, LSL | | | | v1^{L} ∥ v0^{L} |
| | #16 | | | | |
| #3 | ROR r3, r3, #1 | | | | (v1^{L} ∥ v0^{L}) >>> 1 |
| #4 | UXTH r0, r0, ROR | v0^{H} | | | |
| | #16 | | | | |
| #5 | LSL r0, r0, #16 | v0^{H} ∥ 0 | | | |
| #6 | EOR r1, r0, r1, LSR | | v0^{H} ∥ v1^{H} | | |
| | #16 | | | | |
| #7 | ROR r1, r1, #1 | | (v0^{H} ∥ v1^{H}) >>> 1 | | |
| #8 | ORR | | | 0xF0000000 | |
| | r2, r2, #0xF0000000 | | | | |
| #9 | ROR r2, r2, #28 | | | 0x0000000F = 15 | |
| #10 | ROR r1, r1, r2 | | v1^{H} ∥ v0^{H} | | |
| #11 | ROR r3, r3, r2 | | | | v0^{L} ∥ v1^{L} |
| #12 | LSL r1, r1, #16 | | v0^{H} | | |
| #13 | EOR r0, r1, r3, LSR | v0 = v0^{H} ∥ v0^{L} | | | |
| | #16 | | | | |

The instruction #1 is an instruction “UXTH r3, r0.” This instruction allows setting the 16 high-weight bits of the value v0 to zero and recording the result of this operation in the register r3. The result of this operation allows recovering only the 16 low-weight bits v0^{L} of the value v0.

The instruction #2 is an instruction “EOR r3, r3, r1, LSL #16.” This instruction allows concatenating the low-weight bits v1^{L} and v0^{L} of the values v1 and v0 stored in the registers r1 and r0 so as to obtain a first concatenated word v1^{L}∥v0^{L} and allows recording this concatenated word v1^{L}∥v0^{L} in the register r3. In particular, this instruction allows shifting by 16 bits to the left the value v1^{L} before performing a XOR logic operation between this shifted value v1^{L} and the value v0^{L} to obtain the concatenated word v1^{L}∥v0^{L}. The concatenated word v1^{L}∥v0^{L} then has a first portion of 16 high-weight bits including the 16 low-weight bits v1^{L} of the value v1 and a second portion of 16 low-weight bits including the 16 low-weight bits v0^{L} of the value v0.

The instruction #3 is an instruction “ROR r3, r3, #1.” This instruction allows carrying out an operation of rotation by 1 bit to the right on the concatenated word v1^{L}∥v0^{L} so as to obtain a concatenated word shifted by 1 bit by rotation to the right (v1^{L}∥v0^{L})>>>1. This shifted concatenated word is stored in the register r3.

The instruction #4 is an instruction “UXTH r0, r0, ROR #16.” This instruction allows performing a rotation by 16 bits to the right of the value v0 so as to reverse the values v0^{H} of the high-weight bits with the values v0^{L} of the low-weight bits of the value v0, before setting the 16 high-weight bit of the result of the rotation to zero and record the result of this operation in the register r0. The result of this operation allows recovering only the 16 high-weight bits v0^{H} of the value v0.

The instruction #5 is an instruction LSL r0,r0, #16. This instruction allows shifting by 16 bits to the left the value v0^{H}. The result of this operation is then the concatenated word v0^{H}∥0.

The instruction #6 is an instruction “EOR r1, r0, r1, LSR #16.” This instruction allows concatenating the high-weight bits v0^{H} and v1^{H} of the values v0 and v1 so as to obtain a second concatenate word v0^{H}∥v1^{H}, and allows recording this concatenated word v0^{H}∥v1^{H} in the register r1. In particular, this instruction allows isolating the 16 high-weight bits of v1 by shifting v1 by 16 bits to the right before performing a XOR logic operation between the value v0^{H}∥0 and the value v1^{H} to obtain the concatenated word v0^{H}∥v1^{H}. The concatenated word v0^{H}∥v1^{H} then has a first portion of 16 high-weight bits including the 16 high-weight bits v0^{H} of the value v0 and a second portion of 16 low-weight bits including the 16 high-weight bits v1^{H} of the value v1.

The instruction #7 is an instruction “ROR r1, r1, #1.” This instruction allows carrying out an operation of rotation by 1 bit to the right on the concatenated word v0^{H}∥v1^{H} so as to obtain a concatenated word shifted by 1 bit by rotation to the right (v0^{H}∥v1^{H})>>>1. This shifted concatenated word is stored in the register r1.

The instruction #8 is an instruction “ORR r2, r2, =0xF0000000.” This instruction allows performing an OR logic operation between the value of the selection bit Sel_bit stored in the register r2 and the value 0xF0000000 (herein represented according to the hexadecimal system), and allows recording the result of this operation in the register r2. The value of the selection bit being herein equal to 0, the result of the OR logic operation is equal to 0xF0000000.

The instruction #9 is an instruction “ROR r2, r2, #28.” This instruction allows carrying out an operation of rotation by 28 bits to the right on the result of the OR logic operation stored in the register r2, and allows recording the result of this rotation operation in the register r2. In this case, the result of the rotation operation is equal to 0x0000000F in the hexadecimal system, 15 in the decimal system.

The instruction #10 is an instruction “ROR r1, r1, r2.” This instruction allows carrying out an operation of rotation to the right by a number of bits corresponding to the value stored in the register r2 (herein 0x0000000F, a rotation by 15 bits to the right) on the shifted concatenated word (v0^{H}∥v1^{H})>>>1 stored in the register r1, and allows recording the result of this rotation operation in the register r1. In this case, the result of this 15-bit rotation operation corresponds to the concatenated word v1^{H}∥v0^{H} which has a first portion of 16 high-weight bits comprising the 16 high-weight bits v1^{H} of the value v1 and a second portion of 16 low-weight bits comprising the 16 high-weight bits v0^{H} of the value v0. Thus, this result corresponds to a 16-bit rotation of the concatenated word v0^{H}∥ v1^{H}.

The instruction #11 is an instruction “ROR r3, r3, r2.” This instruction allows carrying out an operation of rotation to the right by a number of bits corresponding to the value stored in the register r2 (herein 0x0000000F, a rotation by 15 bits to the right) on the shifted concatenated word (v1^{L}∥v0^{L})>>>1 stored in the register r3, and allows recording the result of this rotation operation in the register r3. In this case, the result of this 15-bit rotation operation corresponds to the concatenated word v0^{L}∥v1^{L} which has a first portion of 16 high-weight bits comprising the 16 low-weight bits v0^{L} of the value v0 and a second portion of 16 low-weight bits comprising the 16 low-weight bits v1^{L} of the value v1. Thus, this result corresponds to a 16-bit rotation of the concatenated word v1^{L}∥v0^{L}.

The instruction #12 corresponds to an instruction “LSL r1, r1, #16.” This instruction allows carrying out an operation of shifting to the left by 16 bits on the concatenated word v1^{H}∥v0^{H} resulting from the rotation operation, and allows recording the result of this shift operation in the register r1. This shift operation allows eliminating the unselected value v1^{H} and keeping only the selected value v0^{H}.

The instruction #13 corresponds to an instruction “EOR r0, r1, r3, LSR #16.” This instruction allows concatenating the 16 high-weight bits v0^{H} and the 16 low-weight bits v0^{L} of the value v0 to recover this selected value v0, and allows recording this recovered value v0 in the register r0. In particular, this instruction firstly shifting by 16 bits to the right the concatenated word v0^{L}∥v1^{L} of the register r3 to obtain v0^{L}∥v1^{L} before performing a XOR logic operation with the value v0^{H} to obtain the concatenated word v0^{H}∥v01 corresponding to the selected value v0.

The table [Table 4] illustrates an example of implementation of the method when the two values v0 and v1 initially stored in the registers r0 and r1 are represented over 32 bits, and when the value of the selection bit Sel_bit initially stored in the register r2 is equal to 1 so as to select the values v1 stored in the register r1.

TABLE 4
Sel_bit = 1

| No Instruction | Instruction | Registre r0 | Registre r1 | Registre r2 | Registre r3 |
|---|---|---|---|---|---|
| #0 | État initial | v0 = v0^{H} ∥ v0^{L} | v1 = v1^{H} ∥ v1^{L} | Sel_bit = 1 | |
| #1 | UXTH r3, r0 | | | | v0^{L} |
| #2 | EOR r3, r3, r1, LSL | | | | v1^{L} ∥ v0^{L} |
| | #16 | | | | |
| #3 | ROR r3, r3, #1 | | | | (v1^{L} ∥ v0^{L}) >>> 1 |
| #4 | UXTH r0, r0, ROR | v0^{H} | | | |
| | #16 | | | | |
| #5 | LSL r0, r0, #16 | v0^{H} ∥ 0 | | | |
| #6 | EOR r1, r0, r1, LSR | | v0^{H} ∥ v1^{H} | | |
| | #16 | | | | |
| #7 | ROR r1, r1, #1 | | (v0^{H} ∥ v1^{H}) >>> 1 | | |
| #8 | ORR | | | 0xF0000001 | |
| | r2, r2, #0xF0000000 | | | | |
| #9 | ROR r2, r2, #28 | | | 0x0000001F = 31 | |
| #10 | ROR r1, r1, r2 | | v0^{H} ∥ v1^{H} | | |
| #11 | ROR r3, r3, r2 | | | | v1^{L} ∥ v0^{L} |
| #12 | LSL r1, r1, #16 | | v1^{H} | | |
| #13 | EOR r0, r1, r3, LSR | v1 = v1^{H} ∥ v1^{L} | | | |
| | #16 | | | | |

The instructions are identical to those described with reference to the table [Table 3]. Nevertheless, the results of the operations carried out by the execution of these instructions differ from those of the table [Table 3] because the value of the selection bit is equal to 1 and no longer 0.

In particular, the result of the OR logic operation of the instruction #8 is equal to 0xF0000001, and no longer 0xF0000000. Thus, the result of the rotation operation of the instruction #9 is equal to 0x0000001F, 31 in the decimal system.

Hence, the rotation operation carried out by the instructions #10 and #11 are rotations over 31 bits, and no longer over 15 bits.

More particularly, the result of the rotation operation of the instruction #10 therefore corresponds to the concatenated word v0^{H}∥v1^{H}. This concatenated word v0^{H}∥v1^{H} has a first portion of 16 high-weight bits comprising the 16 high-weight bits v0^{H} of the value v0 and a second portion of 16 low-weight bits comprising the 16 high-weight bits v1^{H} of the value v1. This result corresponds to a 32-bit rotation of the concatenated word v0^{H}∥v1^{H} obtained after the execution of the instruction #6.

Hence, the result of the rotation operation of the instruction #11 corresponds to the concatenated word v1^{L}∥v0^{L}. This concatenated word v1^{L}∥v0^{L} has a first portion of 16 high-weight bits comprising the 16 low-weight bits v1^{L} of the value v1 and a second portion of 16 low-weight bits comprising the 16 low-weight bits v0^{L} of the value v0. This result corresponds to a rotation of 32 bits of the concatenated word v1^{L}∥v0^{L} obtained after the execution of the instruction #2.

Consequently, the result of the shift operation of the instruction #12 is equal to the 16 high-weight bits v1^{H} of the selected value v1, and the result of the XOR operation, of the instruction #13 gives as a result the concatenated word v1^{H}∥ v1^{L} corresponding to the selected value v1.

The described selection methods may be implemented in the context of a cryptographic process. In particular, the described selection methods may be implemented in the “RSA” and “ElGamal” cryptosystems, the “DSA” (acronym for “Digital Signature Algorithm”) and “ECDSA” (acronym for “Elliptic curve digital signature algorithm”) algorithms and the “ECDH” (acronym for “Elliptic-curve Diffie-Hellman”) protocol. For example, the described selection methods may be implemented in a Montgomery ladder algorithm.

More particularly, the selection bit may be a bit of a cryptographic key that the user wishes to keep secret. For example, such a selection may be implemented to calculate a modular exponentiation or a scalar multiplication according to a bit of the cryptographic key.

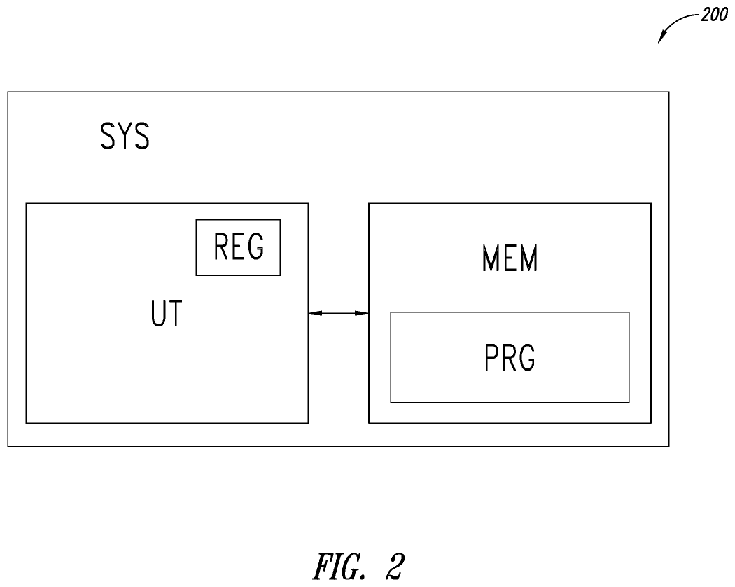

FIG. 2 illustrates an embodiment of a computer system 200, such as a system-on-chip for example. The computer system comprises a processing circuit or unit UT (e.g., a cryptographic processor or a security circuit), and a memory MEM in which a computer program PRG is stored. The memory MEM may typically include one or more RAM memory arrays. The processing unit UT comprises one or more registers and has an architecture supporting a rotation of the register content. The system SYS may typically include one or more other processors, which may, in operation, perform one or more processing operations based on a result of a cryptographic operation performed by the circuitry UT.

The computer program PRG comprises instructions which, when the program is executed by the processing unit UT, cause the latter to implement a selection method such as those described before (e.g., with reference to FIG. 1).

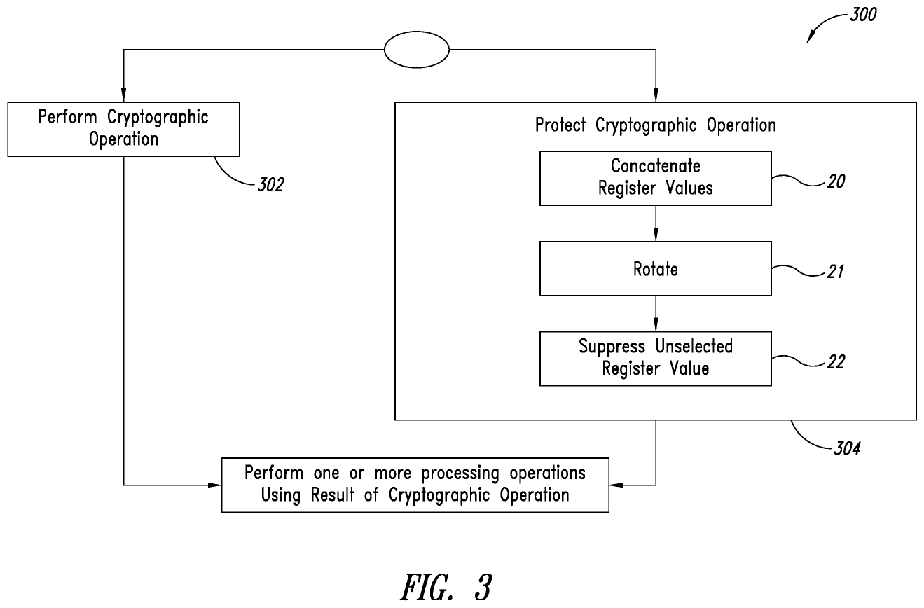

FIG. 3 illustrates an embodiment of a method 300 of performing a cryptographic operation 302 and protecting the cryptographic operation against side channel attacks 304. The method 300 may be performed, for example, using a computing system such as an embodiment of the computing system 200 of FIG. 2. A result of the cryptographic operation 302 may be used to perform one or more processing operations 306, such as authentication operation, generate one or more control signals, etc. While the performing of the cryptographic operation 302 and the protecting of the cryptographic operation 304 are illustrated as being parallel operations, in practice the protecting of the cryptographic operation 304 may be integrated into the performing of the cryptographic operation 302.

A method implemented by a computer for selecting a value amongst two values recorded in two different registers from a selection bit, the method may be summarized as including: concatenating (20) the two values recorded in the two registers so as to obtain a concatenated word including said two values in two distinct portions of the concatenated word, then rotating (21, 21a, 21b) said concatenated word according to the value of the selection bit so as to position the selected value in a given portion of the concatenated word amongst said two portions, then suppressing (22) the unselected value in the concatenated word so as to keep only the selected value in the concatenated word by eliminating the unselected value of the concatenated word.

Said deletion of the unselected value in the concatenated word may include shifting (22) the concatenated word so as to keep only the selected value in the concatenated word by eliminating the unselected value of the concatenated word.

The concatenation may allow concatenating two values over 16 bits so as to obtain a 32-bit concatenated word in which the two values may include within two 16-bit portions of the concatenated word.

Said rotation of said concatenated word may include: a first rotation (21a) of the concatenated word according to a determined number M of bits, M being different from 0 and from a multiple of 16, then a second rotation (21b) of the concatenated word according to a number of bits dependent on the selection bit so as to obtain the selected value over said given portion.

The number of shift bits for the second rotation may be determined by carrying out: an OR logic function between the value of the selection bit and a value equal to 0xN0000000 where N may include between 1 and F in the hexadecimal system and is defined with respect to the determined number M of bits for the first rotation, then a rotation by 28 bits on the value obtained by the OR logic function so as to obtain a value of the number of shift bits for the second rotation.

A computer program product may be summarized as including instructions which, when the program is executed by a computer, result in the latter implementing a method.

A computer system may be summarized as including: a memory in which a computer program product is stored, and a processing unit configured to execute said computer program product.

A method includes performing a cryptographic operation using a processing device. The performing the cryptographic operation includes protecting the performing of the cryptographic operation against side channel attacks by selecting a value amongst two values based on a selection bit. Selecting the value includes concatenating the two values in a register, generating a concatenated word including the two values in two distinct portions of the concatenated word in the register. The concatenated word is rotated according to the value of the selection bit to position the selected value in a determined portion of the concatenated word in the register amongst said two portions. The unselected value in the concatenated word is suppressed. One or more processing operations is performed based on a result of the cryptographic operation.

In an embodiment, the suppressing of the unselected value in the concatenated word comprises shifting the concatenated word in the register.

In an embodiment, the first value is represented by a 16-bit word stored in a first 32-bit register, the second value is represented by a 16-bit word stored in a second register, and the concatenated word is a 32-bit word stored in the first register. In an embodiment, the rotation of the concatenated word comprises: a first rotation of the concatenated word by a determined number M of bits, M being different from 0 and from a multiple of 16; and a second rotation of the concatenated word by a number of bits based on the selection bit. In an embodiment, the number of bits of the second rotation is determined by: performing an OR logic function between the value of the selection bit and a value equal to 0xN0000000 where N is between 1 and F in a hexadecimal system and is defined with respect to the determined number M of bits for the first rotation; and rotating a result of the OR logic function by 28 bits.

In an embodiment, the one or more processing operations comprises generating one or more control signals based on the result of the cryptographic operation. In an embodiment, the one or more processing operations comprises an authentication operation.

In an embodiment, a non-transitory computer-readable medium's contents cause a processing device to perform a method. The method includes performing a cryptographic operation using a processing device. The performing the cryptographic operation includes protecting the performing of the cryptographic operation against side channel attacks by selecting a value amongst two values based on a selection bit. Selecting the value includes concatenating the two values in a register, generating a concatenated word including the two values in two distinct portions of the concatenated word in the register. The concatenated word is rotated according to the value of the selection bit to position the selected value in a determined portion of the concatenated word in the register amongst said two portions. The unselected value in the concatenated word is suppressed. One or more processing operations is performed based on a result of the cryptographic operation.

In an embodiment, the suppressing of the unselected value in the concatenated word comprises shifting the concatenated word in the register.

In an embodiment, the first value is represented by a 16-bit word stored in a first 32-bit register, the second value is represented by a 16-bit word stored in a second register, and the concatenated word is a 32-bit word stored in the first register.

In an embodiment, the contents comprise instructions executable by the processing device.

In an embodiment, a system comprises a plurality of registers, and processing circuitry coupled to the plurality of registers. The processing circuitry, in operation, performs a cryptographic operation. The performing the cryptographic operation includes protecting the performing of the cryptographic operation against side channel attacks by selecting a value amongst two values based on a selection bit. Selecting the value includes concatenating the two values in a register of the plurality of registers, generating a concatenated word including the two values in two distinct portions of the concatenated word in the register. The concatenated word is rotated according to the value of the selection bit to position the selected value in a determined portion of the concatenated word in the register amongst said two portions. The unselected value in the concatenated word is suppressed. One or more processing operations is performed based on a result of the cryptographic operation.

In an embodiment, the suppressing of the unselected value in the concatenated word comprises shifting the concatenated word in the register.

In an embodiment, the first value is represented by a 16-bit word stored in a first 32-bit register of the plurality of registers, the second value is represented by a 16-bit word stored in a second register of the plurality of registers, and the concatenated word is a 32-bit word stored in the first register.

In an embodiment, the rotation of the concatenated word comprises: a first rotation of the concatenated word by a determined number M of bits, M being different from 0 and from a multiple of 16; and a second rotation of the concatenated word by a number of bits based on the selection bit.

In an embodiment, the number of bits of the second rotation is determined by: performing an OR logic function between the value of the selection bit and a value equal to 0xN0000000 where N is between 1 and F in a hexadecimal system and is defined with respect to the determined number M of bits for the first rotation; and rotating a result of the OR logic function by 28 bits.

In an embodiment, the one or more processing operations comprises generating one or more control signals based on the result of the cryptographic operation.

In an embodiment, the processing circuitry comprises: cryptographic circuitry, which, in operation, performs the cryptographic operation; and control circuitry, which, in operation, generates one or more control signals based on a result of the cryptographic operation.

In an embodiment, a device comprises a plurality of registers, and cryptographic circuitry coupled to the plurality of registers. The cryptographic circuitry, in operation performs a cryptographic operation, the performing the cryptographic operation including protecting the performing of the cryptographic operation against side channel attacks by selecting a value amongst two values based on a selection bit. The selecting the value includes: concatenating the two values in a register of the plurality of registers, generating a concatenated word including the two values in two distinct portions of the concatenated word in the register; rotating the concatenated word according to the value of the selection bit to position the selected value in a determined portion of the concatenated word in the register amongst said two portions; and suppressing the unselected value in the concatenated word.

In an embodiment, the suppressing of the unselected value in the concatenated word comprises shifting the concatenated word in the register.

In an embodiment, the first value is represented by a 16-bit word stored in a first 32-bit register of the plurality of registers, the second value is represented by a 16-bit word stored in a second register of the plurality of registers, and the concatenated word is a 32-bit word stored in the first register. In an embodiment, the rotation of the concatenated word comprises: a first rotation of the concatenated word by a determined number M of bits, M being different from 0 and from a multiple of 16; and a second rotation of the concatenated word by a number of bits based on the selection bit.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
performing a cryptographic operation using a processing device, the performing the cryptographic operation including protecting the performing of the cryptographic operation against side channel attacks by selecting a value amongst two values based on a selection bit, the selecting the value including:
concatenating the two values in a register, generating a concatenated word including the two values in two distinct portions of the concatenated word in the register;
rotating the concatenated word according to the value of the selection bit to position the selected value in a determined portion of the concatenated word in the register amongst said two portions; and
suppressing the unselected value in the concatenated word; and
performing one or more processing operations based on a result of the cryptographic operation.

2. The method according to claim 1, wherein the suppressing of the unselected value in the concatenated word comprises shifting the concatenated word in the register.

3. The method according to claim 1, wherein the first value is represented by a 16-bit word stored in a first 32-bit register, the second value is represented by a 16-bit word stored in a second register, and the concatenated word is a 32-bit word stored in the first register.

4. The method according to claim 3, wherein the rotation of the concatenated word comprises:
a first rotation of the concatenated word by a determined number M of bits, M being different from 0 and from a multiple of 16; and
a second rotation of the concatenated word by a number of bits based on the selection bit.

5. The method according to claim 4, wherein the number of bits of the second rotation is determined by:
performing an OR logic function between the value of the selection bit and a value equal to 0xN0000000 where N is between 1 and F in a hexadecimal system and is defined with respect to the determined number M of bits for the first rotation; and
rotating a result of the OR logic function by 28 bits.

6. The method according to claim 1, wherein the one or more processing operations comprises generating one or more control signals based on the result of the cryptographic operation.

7. The method according to claim 1, wherein the one or more processing operations comprises an authentication operation.

8. A non-transitory computer-readable medium having contents which cause a processing device to perform a method, the method comprising:
performing a cryptographic operation, the performing the cryptographic operation including protecting the performing of the cryptographic operation against side channel attacks by selecting a value amongst two values based on a selection bit, the selecting the value including:
concatenating the two values in a register, generating a concatenated word including the two values in two distinct portions of the concatenated word in the register;
rotating the concatenated word according to the value of the selection bit to position the selected value in a determined portion of the concatenated word in the register amongst the two portions; and
suppressing the unselected value in the concatenated word; and
performing one or more processing operations based on a result of the cryptographic operation.

9. The non-transitory computer-readable medium of claim 8, wherein the suppressing of the unselected value in the concatenated word comprises shifting the concatenated word in the register.

10. The non-transitory computer-readable medium of claim 8, wherein the first value is represented by a 16-bit word stored in a first 32-bit register, the second value is represented by a 16-bit word stored in a second register, and the concatenated word is a 32-bit word stored in the first register.

11. The non-transitory computer-readable medium of claim 8, wherein the contents comprise instructions executable by the processing device.

12. A system, comprising:
a plurality of registers; and
processing circuitry coupled to the plurality of registers, wherein the processing circuitry, in operation:
performs a cryptographic operation, the performing the cryptographic operation including protecting the performing of the cryptographic operation against side channel attacks by selecting a value amongst two values based on a selection bit, the selecting the value including:
concatenating the two values in a register of the plurality of registers, generating a concatenated word including the two values in two distinct portions of the concatenated word in the register;
rotating the concatenated word according to the value of the selection bit to position the selected value in a determined portion of the concatenated word in the register amongst said two portions; and
suppressing the unselected value in the concatenated word; and
performing one or more processing operations based on a result of the cryptographic operation.

13. The system according to claim 12, wherein the suppressing of the unselected value in the concatenated word comprises shifting the concatenated word in the register.

14. The system according to claim 12, wherein the first value is represented by a 16-bit word stored in a first 32-bit register of the plurality of registers, the second value is represented by a 16-bit word stored in a second register of the plurality of registers, and the concatenated word is a 32-bit word stored in the first register.

15. The system according to claim 14, wherein the rotation of the concatenated word comprises:
a first rotation of the concatenated word by a determined number M of bits, M being different from 0 and from a multiple of 16; and
a second rotation of the concatenated word by a number of bits based on the selection bit.

16. The system according to claim 15, wherein the number of bits of the second rotation is determined by:
performing an OR logic function between the value of the selection bit and a value equal to 0xN0000000 where N is between 1 and F in a hexadecimal system and is defined with respect to the determined number M of bits for the first rotation; and
rotating a result of the OR logic function by 28 bits.

17. The system according to claim 12, wherein the one or more processing operations comprises generating one or more control signals based on the result of the cryptographic operation.

18. The system of claim 17, wherein the processing circuitry comprises:
cryptographic circuitry, which, in operation, performs the cryptographic operation; and
control circuitry, which, in operation, generates one or more control signals based on a result of the cryptographic operation.

19. A device, comprising:
a plurality of registers; and
cryptographic circuitry coupled to the plurality of registers, wherein the cryptographic circuitry, in operation:
performs a cryptographic operation, the performing the cryptographic operation including protecting the performing of the cryptographic operation against side channel attacks by selecting a value amongst two values based on a selection bit, the selecting the value including:
concatenating the two values in a register of the plurality of registers, generating a concatenated word including the two values in two distinct portions of the concatenated word in the register;
rotating the concatenated word according to the value of the selection bit to position the selected value in a determined portion of the concatenated word in the register amongst said two portions; and
suppressing the unselected value in the concatenated word.

20. The device according to claim 19, wherein the suppressing of the unselected value in the concatenated word comprises shifting the concatenated word in the register.

21. The device according to claim 19, wherein the first value is represented by a 16-bit word stored in a first 32-bit register of the plurality of registers, the second value is represented by a 16-bit word stored in a second register of the plurality of registers, and the concatenated word is a 32-bit word stored in the first register.

22. The device according to claim 21, wherein the rotation of the concatenated word comprises:
a first rotation of the concatenated word by a determined number M of bits, M being different from 0 and from a multiple of 16; and
a second rotation of the concatenated word by a number of bits based on the selection bit.
